(19) United States
(12) Patent Application Publication
(10) Pub. No.: US 2007/0190976 A1
(43) Pub. Date: Aug. 16, 2007

(54) Member authentication system

(75) Inventors: Hirokazu Hoshino, Tokyo (JP); Sonoi Oho, Tokyo (JP)

Correspondence Address: BURR & BROWN, PO BOX 7068, SYRACUSE, NY, 13261-7068, US

(73) Assignee: Ionos Co., Ltd., Setagaya-Ku, TOKYO (JP)

(21) Appl. No.: 10/592,416

(22) PCT Filed: Mar. 12, 2004
(86) PCT No.: PCT/JP04/03253

§ 371 Date: Sep. 11, 2006

(51) Int. Cl. H04M 1/66

(52) U.S. Cl. 455/411

(57) ABSTRACT

A user calls a specific number of an authentication center (member authentication device) from a mobile terminal in a state of caller line identity presentation and hangs up the mobile terminal after one ring. The authentication center can recognize the number of the mobile terminal of the caller in spite of the hang-up of the call as long as the phone number of the caller is presented during the ring. The member authentication device searches a database in the authentication center to compare the caller's number on the mobile terminal with the member registered caller's numbers for verification. Member authentication is thus executed and its result is outputted.

### TECHNICAL FIELD

The present invention relates to a simple authentication technique for authenticating a member by using a mobile phone or the like in the use of recreational facilities, merchandise purchases, service use in shops, or the like.

### BACKGROUND ART

In pachinko parlors, recreational facilities, and the like, a business model employing a member registration system to their own facilities, for adding various points to a customer who has subscribed as a member (also referred to as a member customer or a member) to retain a specific number of customers in the growing competitions for customer acquisition with other facilities, is being established.

In the member registration system, in general, a member himself/herself or points possessed by the member are managed by using a magnetic stripe card, a barcode, or an IC card to authenticate the member or to manage the points in a computer system provided in the facility.

In the member registration system, however, for entering a recreational facility or for using a facility or equipment, it is essential to carry a medium such as a membership card for certifying membership. Therefore, such a system using the membership card tends to be avoided.

Specifically, as the number of facilities employing the membership card system increases, the member customer has to carry a larger number of cards to go out. For the member customer, the system requiring the membership card is more troublesome than it is worth.

In order to avoid the above problem, a large number of member authentication systems employing a mobile phone, the private ownership rate of which is rapidly growing, have been proposed. In general, in the member authentication systems using the mobile phone, for example, a phone call is made from a mobile phone to a telephone number of an authentication center set for each recreational facility. Following audio questions from the authentication center, a membership number, a PIN, or the like is transmitted in a tone signal for authentication.

When the mobile phone has an image display function, access is made to a preset uniform resource locator (URL) of the authentication center to call an authentication screen. By entering a membership number and a password corresponding to the membership number, the entry to the facility or the like is authenticated.

In the member authentication system using the mobile phone as described above, a single mobile phone can be used for authenticating the membership of a plurality of recreational facilities. The member authentication system frees the member from the hassle of carrying a membership card for each recreational facility or shop, unlike in the conventional case.

Even in the member authentication system using the mobile phone as described above, however, the member customer is required to pay the cost for calls to the authentication center, a packet communication fee for network access, and the like. Therefore, it is inevitable to impose an economic burden or a complicated terminal operation on the member customer.

### DISCLOSURE OF THE INVENTION

An object of the present invention is to provide a method (technique) for enabling the realization of simple member authentication without requiring a member customer to perform a complicated operation nor generating an economical burden on the member customer in a member authentication technique using a mobile terminal or the like.

In order to achieve the above object, according to the present invention, a phone call is made from a mobile terminal to a specific number of an authentication center in a state of caller line identity presentation. At this time, the call may be hung up immediately after the verification of the call. Even if the call is hung up, the authentication center can recognize the number of the mobile terminal of the caller as long as the caller's number in the call is displayed. Therefore, a search is made through a database in the authentication center to compare a member-subscribed caller's number with the caller's number for verification. In this manner, a member authentication processing is executed and its result is outputted.

With the method as described above, when using a recreational facility or the like, a member customer only needs to dial a telephone number of the recreational facility from his/her own mobile terminal (i.e., mobile phone) and hang up on the first ring to complete the member authentication. Since the authentication center (i.e., member authentication device) does not answer the call on the first ring, the mobile terminal having made the call is not charged.

The call may be hung up by directly operating the mobile terminal or by attaching (i.e., connecting) a control device such as a personal computer or an adapter to the mobile terminal to perform call and hang up control. Furthermore, it may be the authentication center that performs the hang up control.

A first member authentication method of the present invention includes the steps of:

recognizing a caller's number of a mobile terminal based on a call made from the mobile terminal in a caller line identity presentation state to a specific number for membership authentication; and

executing a member authentication processing by searching a database for a member-subscribed caller number corresponding to the caller's number for verification, after the call is hung up without waiting for a receiving party to answer, and outputting the result of the member authentication processing.

According to a configuration of the member authentication method, the number of rings of the call on the receiving party may be limited by control of the control means connected to the mobile terminal so as to hang up the call before the receiving party answers. Alternatively, the number of rings of the call on the receiving party may be limited by the mobile terminal itself to hang up the call without waiting for the receiving party to answer. Further, the number of rings of the call on the receiving party is at least one.

A second member authentication method of the present invention includes:

an identification step of identifying an individual number of a mobile terminal present within a service area, in accordance with power activation of the mobile terminal; and

an authentication step of receiving the individual number from the identification step and comparing the received individual number with a content of a database for verification,

in which the authentication step further includes: recognizing, when a predetermined number of power-ON and power-OFF operations of the mobile terminal are repeated within a predetermined time, an authentication request from the mobile terminal; searching the database for the individual number; and outputting the result of member authentication.

A third member authentication method of the present invention includes the steps of:

transmitting a request of using a content or an application from a client terminal to an information transmission server;

receiving, at the client terminal, an instruction of executing hang-up of a call immediately after the call is made, from an authentication server that operates in conjunction with the information transmission server;

urging, at the client terminal, the execution of hang-up of the call immediately after the call is made from a telephone of a user;

transmitting a caller's number of the telephone and an ID of the client terminal to the authentication server upon acceptance of the processing of hanging up the call immediately after the call is made from the telephone;

executing a callback to the telephone from the authentication server through a CTI server; and

notifying the authentication server of authentication completion after accepting an approval operation performed in the telephone in response to the callback.

Further, a first member authentication system of the present invention includes:

means for recognizing a caller's number of a mobile terminal based on a call made from the mobile terminal in a caller line identity presentation state to a specific number for membership authentication; and

means for executing a member authentication processing by searching a database for a member-subscribed caller number corresponding to the caller's number for verification, after the call is hung up without waiting for a receiving party to answer, and outputting the result of the member authentication processing.

According to a configuration of the member authentication system, the number of rings of the call on the receiving party may be limited by control of the control means connected to the mobile terminal so as to hang up the call without waiting for the receiving party to answer. Alternatively, the number of rings of the call on the receiving party may be limited by the mobile terminal itself so as to hang up the call without waiting for the receiving party to answer. Further, the number of rings in the call for the receiving party is at least one.

A second member authentication system of the present invention includes:

an identification means for identifying an individual number of a mobile terminal present within a service area, in accordance with power activation of the mobile terminal; and

an authentication means for receiving the individual number from the identification means and comparing the received individual number with a content of a database for verification,

in which the authentication means further recognizes, when a predetermined number of power-ON and power-OFF operations of the mobile terminal are repeated within a predetermined time, an authentication request from the mobile terminal, searches the database for the individual number, and outputs the result of member authentication.

A third member authentication system of the present invention includes:

means for transmitting a request of using a content or an application from a client terminal to an information transmission server;

means for receiving, at the client terminal, an instruction of executing hang-up of a call immediately after the call is made, from an authentication server that operates in conjunction with the information transmission server;

means for urging, at the client terminal, the execution of hang-up of the call immediately after the call is made from a telephone of a user;

means for transmitting a caller's number of the telephone and an ID of the client terminal to the authentication server upon acceptance of the processing of hanging up the call immediately after the call is made from the telephone;

means for executing a callback to the telephone from the authentication server through a CTI server; and

means for notifying the authentication server of authentication completion after accepting an approval operation performed in the telephone in response to the callback.

According to the present invention, a member customer corresponding to a user only needs to execute a simple operation by using a mobile terminal or the like, which may not be charged, in order to complete the authentication processing. As a result, it is possible to realize simple member authentication (i.e., personal authentication) to be performed in the recreational facility, the service over the network, and the like.

### BRIEF DESCRIPTION OF THE DRAWINGS

FIG. 1 is an explanatory view showing a system configuration according to a first embodiment of the present invention;

FIG. 2 is a functional block diagram of the first embodiment;

FIG. 3 is an operation sequence diagram of the first embodiment;

FIG. 4 is a system configuration diagram of a modification example of the first embodiment;

FIG. 5 is an operation sequence diagram of the modification example of the first embodiment;

FIG. 6 is a system configuration diagram of another modification example of the first embodiment;

FIG. 7 is an operation sequence diagram of the other modification example of the first embodiment;

FIG. 8 is a schematic explanatory view of a second embodiment;

FIG. 9 is an operation sequence diagram of the second embodiment;

FIG. 10 is a system configuration diagram of a third embodiment;

FIG. 11 is an explanatory view showing the contents of an authentication information database of the third embodiment;

FIG. 12 is a system configuration view of a modification example of the third embodiment;

FIG. 13 is an explanatory view showing the contents of an authentication information database of a modification example of the third embodiment;

FIG. 14 is an explanatory view showing the contents of an access information database of the modification example of the third embodiment;

FIG. 15 is a system configuration view showing another modification example of the third embodiment; and

FIG. 16 is an explanatory view showing the contents of an authentication information database in the other modification example of the third embodiment.

### BEST MODE FOR CARRYING OUT THE INVENTION

Next, embodiments of the present invention will be described with reference to the drawings.

### First Embodiment

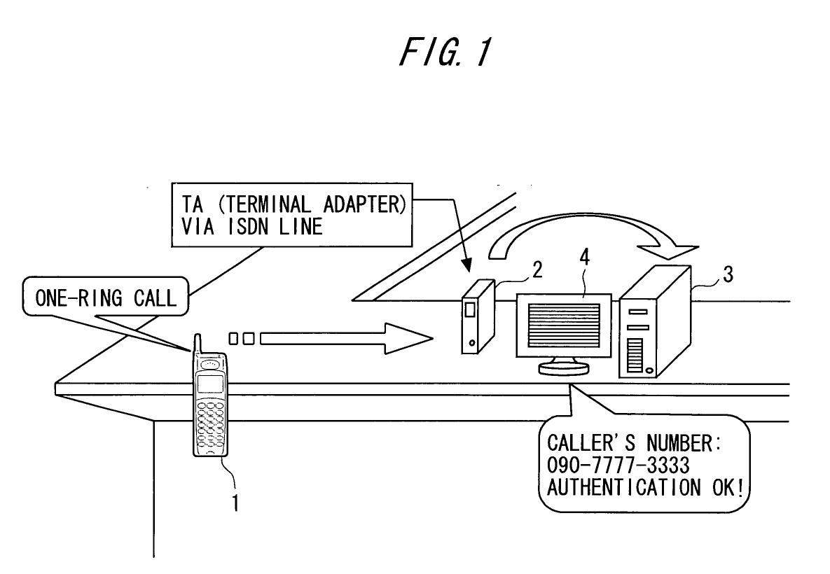

FIG. 1 shows a system configuration in a first embodiment of the present invention. As shown in FIG. 1, a member authentication system includes a mobile phone (i.e., mobile terminal) 1 and a personal computer (PC) 3. A called device 2 (i.e., terminal adapter: TA and the like) that ends a telephone line such as an ISDN line and a display device 4 are connected to the personal computer 3. The called device 2, the personal computer 3, and the display device 4 constitute a member authentication device (i.e., authentication center).

Although an illustration is omitted, the personal computer 3 includes a main memory apparatus (MM), a hard disk drive (HD), and the like around a central processing unit (CPU). The hard disk drive (HD) stores not only an operating system (OS) but also an authentication program, a communication program, a database (DB), and the like. The central processing unit (CPU) sequentially reads various programs such as the authentication program via the main memory apparatus (MM) to execute the following control.

The personal computer 3 and the called device 2 are connected (i.e., interfaced) to each other through a serial cable such as RS-232C or USB. The personal computer 3 can also be connected to a keyboard (not shown) or the like in addition to the called device 2.

In the database (DB) stored in the hard disk drive (HD) a member's name, how to write the name in hiragana, zip code, address, sex, date/year of birth, mobile phone number, mobile phone e-mail address, and the like are registered. These personal information may be input by an operator based on information acquired in advance from a member customer for the subscription or may be input by the member himself/herself from the mobile phone 1 by using a network connection function of the mobile phone 1.

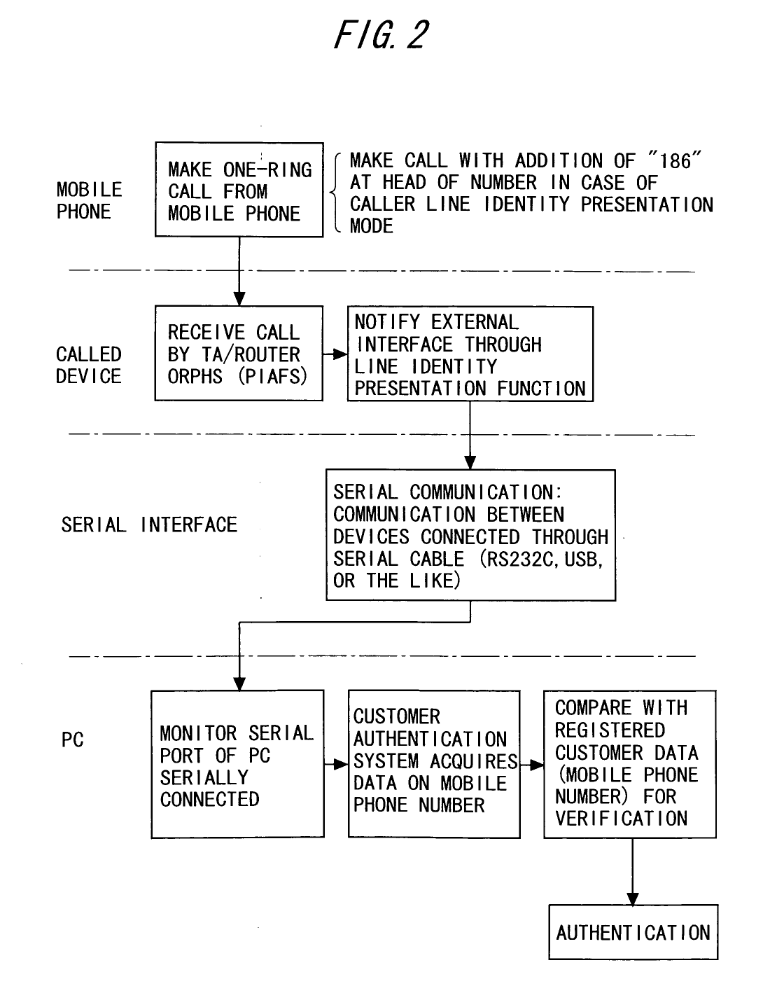

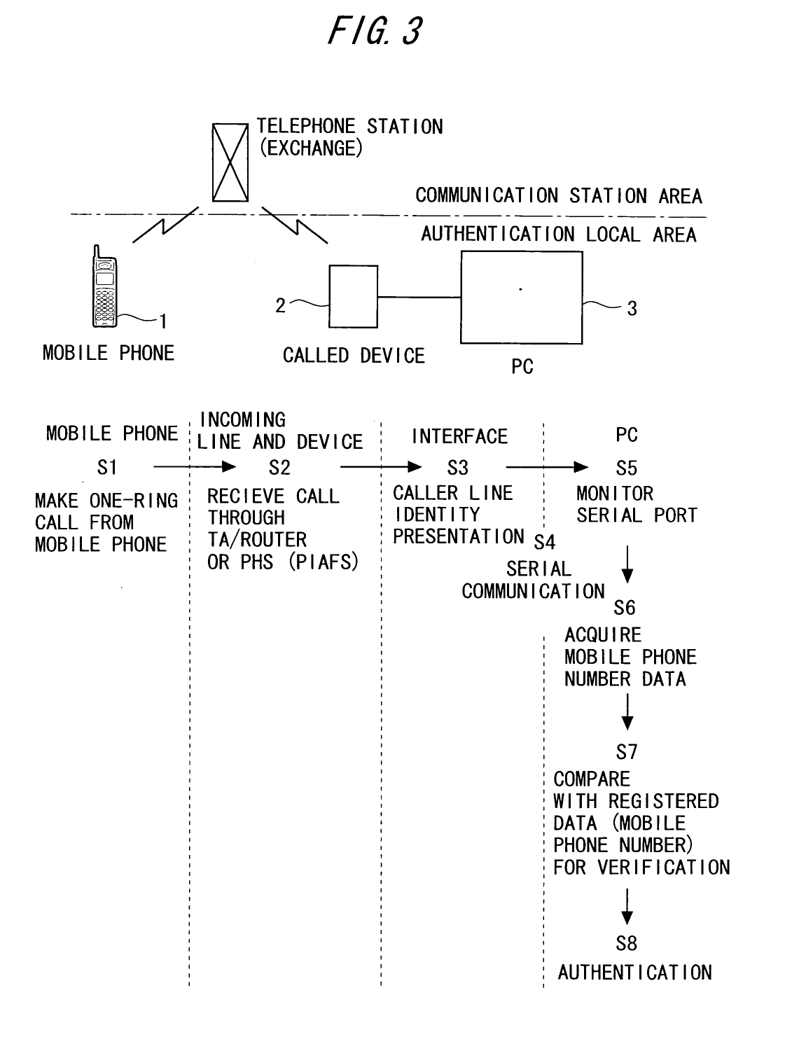

FIG. 2 is a block diagram showing a functional configuration of the mobile phone 1, the called device 2, the personal computer 3, and the like. FIG. 3 is a block diagram showing an operation sequence of the mobile phone 1, the called device 2, the personal computer 3, and the like.

As shown in FIGS. 2 and 3, a call is made from the mobile phone 1 to a telephone number provided for the called device 2 in a caller line identity display (i.e., presentation) mode. At this time, by making the call adding a number for displaying a caller's telephone number, for example, “186” in the case of Japan, to the telephone number (i.e., specific number) of the other side (i.e., receiving party) for displaying the caller's number, the receiving party can recognize the caller's telephone number.

The user (i.e., member customer) may cut the phone line after only one ring from the mobile phone 1. At this time, since the called device 2 can recognize an incoming call from the caller's number even if the phone line is cut after one ring, the caller's number is passed to an external interface by the number presentation function provided for the called device 2. Call with one ring is normally referred to as “one call” or “one-ring call” and, in a strict sense, denotes the number of rings for the receiving party side before the receiving party answers the call.

In the above description, the phone line is cut by a user (i.e., member customer) himself/herself after one ring (i.e., one call). The phone line cut function based on the single-ring call may be provided for the called device 2.

Next, the caller's number from the mobile phone 1 is transmitted to the personal computer (PC) 3 via the serial cable. The central processing unit (CPU) of the personal computer 3 monitors a serial port. Upon detection of a hang up from the called device 2, the CPU receives the caller's number (i.e., mobile phone number).

Next, the central processing unit (CPU) searches through the database (DB) in the hard disk drive (HD) to verify each mobile phone number of the member customer to find a number identical with the caller's number.

When the identical number is found, the user is authenticated as a member to pass the result of authentication to another program. Another program may be a program, for example, for allowing the display device 4 to display the result of authentication or may be a program that increases the number of points of the member customer in accordance with the number of uses.

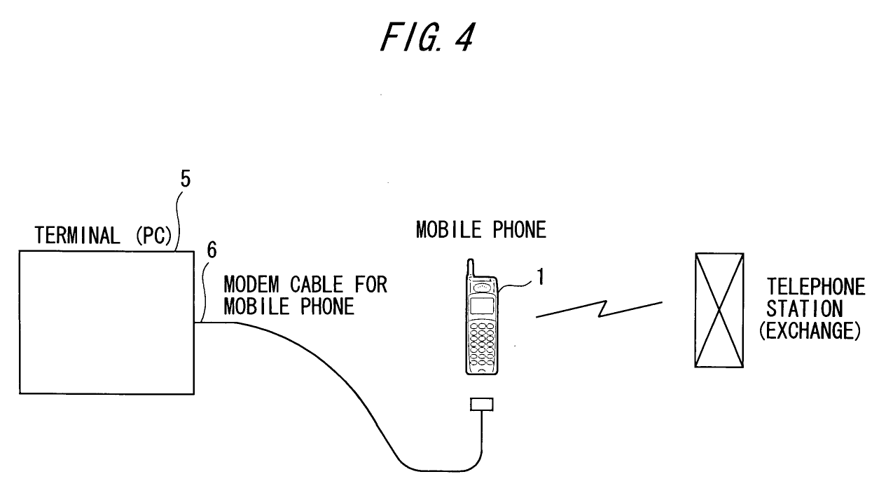

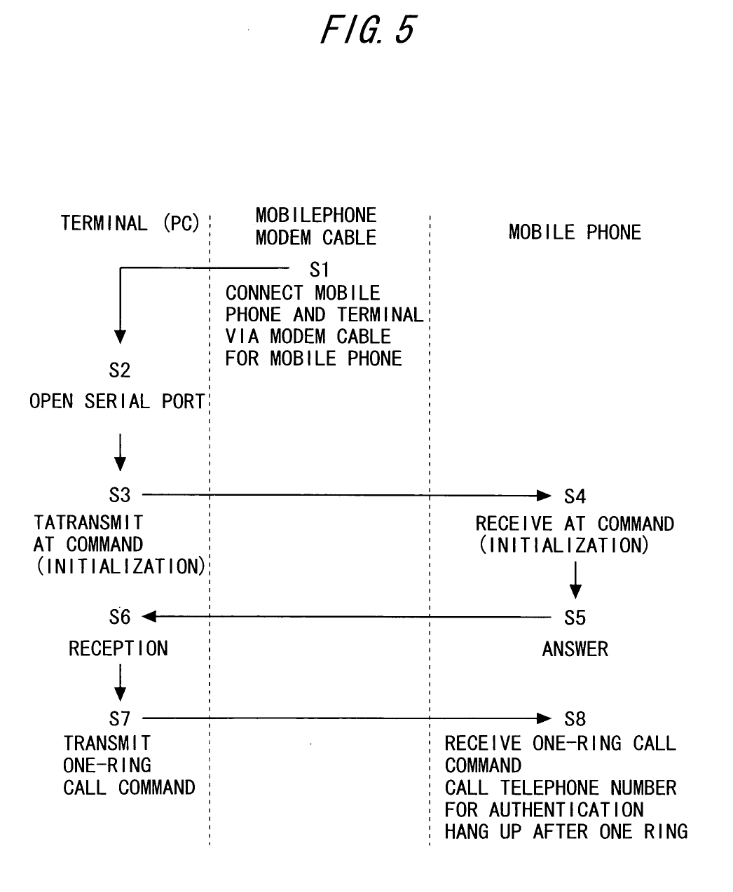

FIGS. 4 and 5 show a modification example of the first embodiment described above. In the modification example, a terminal (PC) 5 is connected to the mobile phone 1. The call control to the mobile phone 1 is performed from the terminal 5. The configuration of the receiving party is the same as that described above with reference to FIGS. 1 to 3.

In the modification example, the terminal 5 is connected to the mobile phone 1 via a modem cable 6 connected through the interface such as RS-232C or USB. From the terminal 5, the mobile phone 1 can be controlled by a control command such as an AT command via the modem.

As the control command such as the AT command as described above, commands allowing the control of opening a port, the initialization of the modem, and the number of calls (i.e., rings) are prepared. By using these commands, a command control program is stored in the terminal 5. The mobile phone 1 is controlled to ring only once the telephone number of the called device 2.

In this manner, the call from the mobile phone 1 is controlled by using the terminal 5 connected via the modem cable 6. As a result, it is no longer necessary for the member customer himself/herself to cut the phone line by the operation after a single ring. Therefore, the operation by the member customer for the authentication is more simplified.

Although the terminal 5 may be a desktop or laptop personal computer, the terminal 5 is preferably a compact computer such as a personal digital assistant (PDA) excellent in portability. Furthermore, the terminal 5 may be a kind of adapter only required to be connected to a connector section of the mobile phone 1 after configuring the control program in the terminal 5 as a ROM. In the case of the adapter configuration as described above, for the entrance to a recreational facility, the simple attachment of the adapter to his/her own mobile phone 1 allows the called device 2 to automatically process a call with one ring, up to the line disconnection.

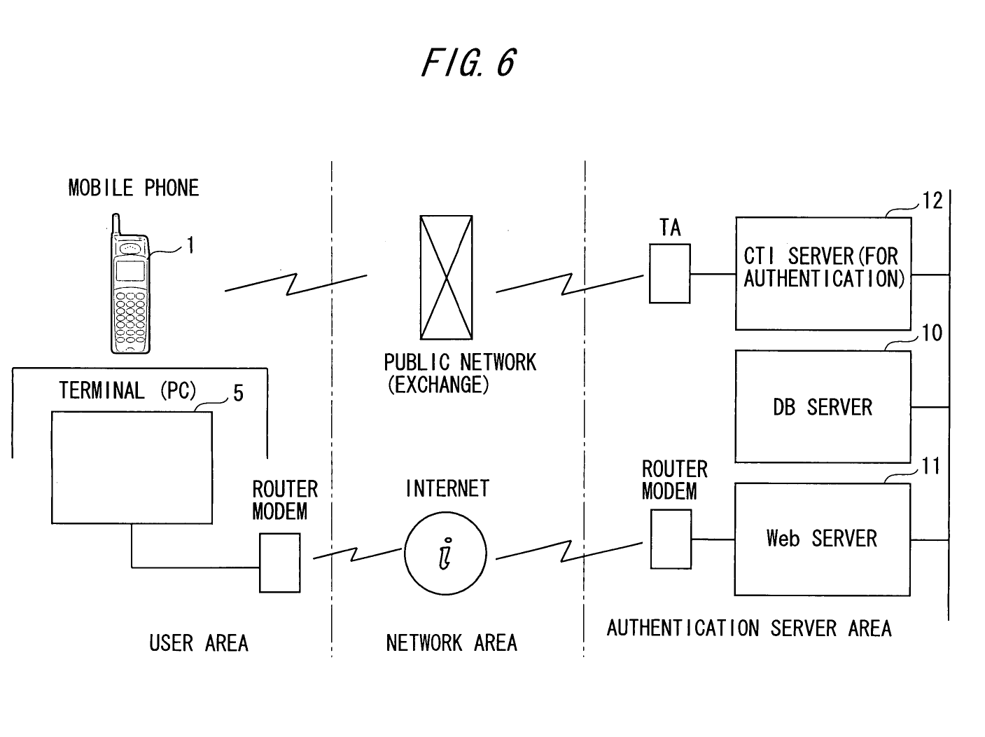

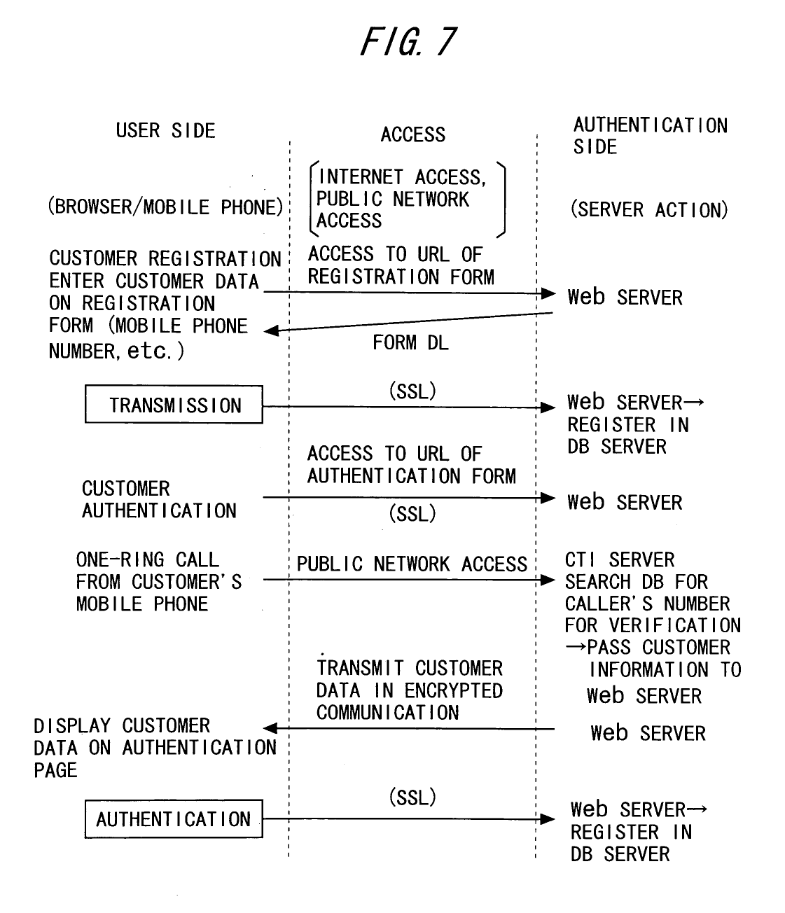

FIGS. 6 and 7 show another modification example of the above-described first embodiment. This modification example is the same as that described with reference to FIGS. 1 to 3 in the authentication processing using the mobile phone 1 but differs in that the member customer can display the result of authentication by using the terminal (PC) 5.

Specifically, in the case where personal authentication is required as in the case of the Internet shopping and the like, the member customer is authenticated by transmitting an ID or a password entered on a WEB (i.e., WWW: World Wide Web) by using a communication system protected with an encryption technique such as a secure sockets layer (SSL) in a conventional technique. In this modification example, however, the authentication processing is performed on the mobile phone 1 in parallel to the display on the WEB.

The user (i.e., member customer) first enters a predetermined URL from the terminal 5 to display a member registration screen of the authentication server. Then, following a displayed registration form, the user enters the name, the mobile phone number, and the like. The personal information entered in this manner is accumulated in a database server (DB server) 10.

Next, the member customer makes an access from the terminal 5 to the URL of the WEB server 11, by which the member customer wishes to be authenticated, via the Internet and then enters his/her own ID to display the authentication screen of the WEB server 11.

In parallel to the processing in the terminal 5 as described above, the member customer makes a phone call to a telephone number associated with the WEB server 11 after putting his/her own mobile phone 1 into the caller line identity display mode. The call may be immediately hung up after only one ring.

A CTI server 12, which has received the incoming call from the mobile phone 1 over a public network, passes the caller's number to the DB server 10. The DB server 10 verifies the caller's number with the contents of its own database. When the corresponding telephone number is found, the DB server 10 outputs an authentication signal to the WEB server 11. The WEB server 11, which has received the authentication signal, creates an authentication completion screen to cause the terminal 5 to display an authentication screen.

In this manner, in the modification example shown in FIGS. 6 and 7, even for the authentication on the Internet, call authentication from the mobile phone 1 can be used. As a result, a simple and secure authentication processing without imposing a complicated operation and an economic burden on the member customer is made possible.

### Second Embodiment

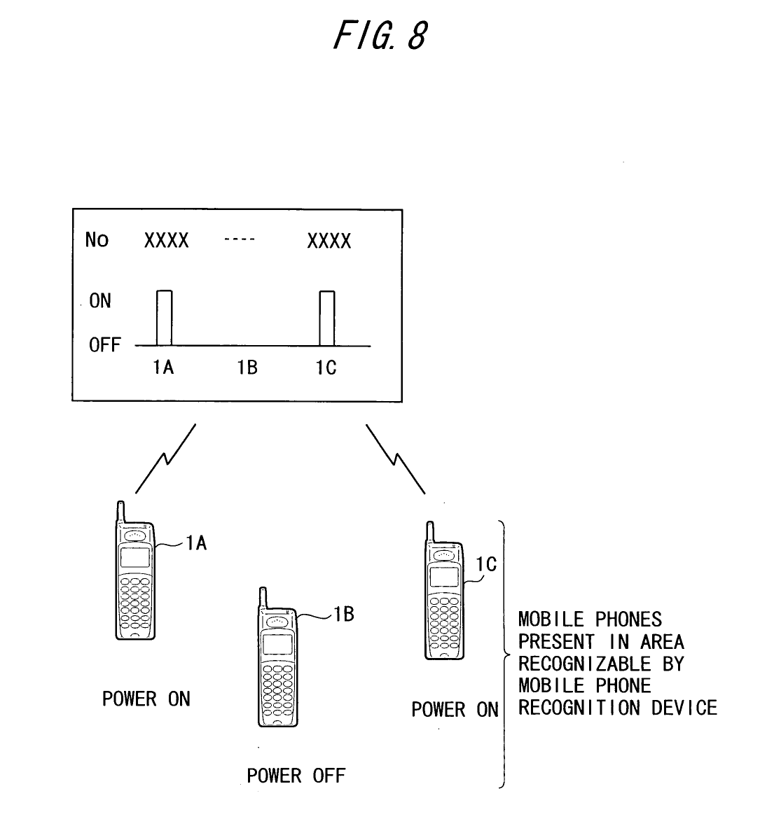

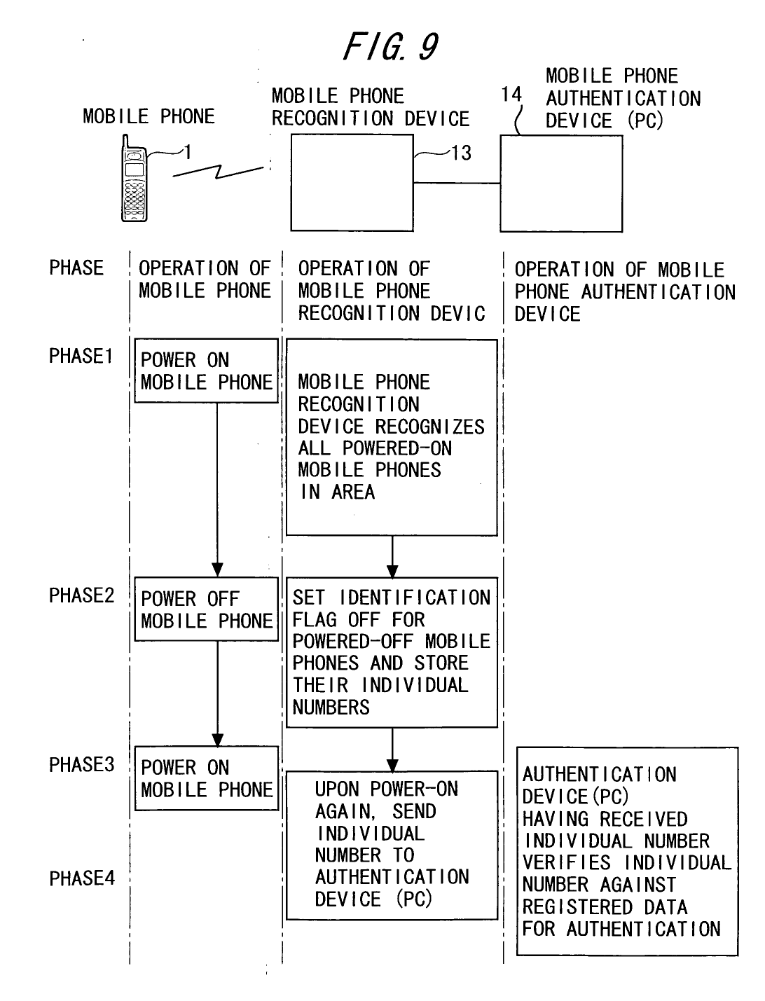

FIGS. 8 and 9 are an explanatory view and a sequence diagram in the second embodiment, respectively. FIGS. 8 and 9 show a mechanism of authentication, noticing the fact that the mobile phone 1 constantly transmits a manufacture number (i.e., individual number) of the mobile phone 1 to a mobile phone recognition device 13 in a base station.

Specifically, the recognition device 13 constantly recognizes the mobile phones 1 (i.e., 1A to 1C) in a power-ON state with in a service area of the base station. In this example, the mobile phones 1A and 1C are powered ON (i.e., in a power activation state), whereas the mobile phone 1B is powered OFF (i.e., in a power deactivation state). Therefore, the recognition device 13 recognizes the mobile phones 1A and 1C by their manufacture numbers (i.e., individual numbers).

A mobile authentication device (PC) 14 connected to the recognition device 13 includes the same database as that in the above-described example. In the database, besides the mobile phone number, a mobile phone manufacture number (i.e., individual number) is registered.

The authentication device 14 receives the individual numbers of the mobile phones 1A and 1C in the power-ON state within the service area from the recognition device 13.

In this state, the member customer who wishes to be authenticated executes the operation shown in FIG. 9. Specifically, if the member customer owning the mobile phone 1B wishes to be authenticated, the member customer powers ON his/her own mobile phone 1B from the power-OFF state. As a result, the recognition device 13 recognizes the presence of the mobile phone 1B within the service area to notify the authentication device 14 of the individual number of the mobile phone 1B. Upon reception of the individual number of the mobile phone 1B from the recognition device 13, the authentication device 14 activates an authentication timer provided for the authentication device 14 and sets an identification flag ON.

Next, the member customer owning the mobile phone 1B powers OFF the mobile phone 1B within a given time (for example, within a minute) after powering ON. By the operation, the recognition device 13 can no longer recognize the individual number of the mobile phone 1B within the service area and therefore notifies the authentication device 14 of the service area non-presence information of the individual number. At this time, the authentication device 14 updates the identification flag of the individual number from ON to OFF.

Next, the member customer owning the mobile phone 1B powers ON the mobile phone 1B again. By this operation, the recognition device 13 recognizes again the individual number of the mobile phone 1B within the service area to notify the authentication device 14 of the information. The authentication device 14 updates the authentication flag of the mobile phone 1B to ON again.

In this manner, when a predetermined number of a series of authentication ON, OFF, and ON operations are repeated for the mobile phone 1B having a specific individual number within a given time, the authentication device 14 searches the individual number from the database. When a number identical with the individual number is found, an authentication request for the individual number is authenticated as being legitimate.

As described above, in the second embodiment, by only repeating a power ON/OFF operation of the mobile phone 1B without performing a call operation itself by the mobile phone 1B, the authentication processing is completed.

### Third Embodiment

A third embodiment intends to realize a user authentication technique with “one-ring call (i.e., one call)” from a telephone (i.e., a mobile phone or a fixed-line phone) established by the combination of a server and a client or computer telephony integration (CTI).

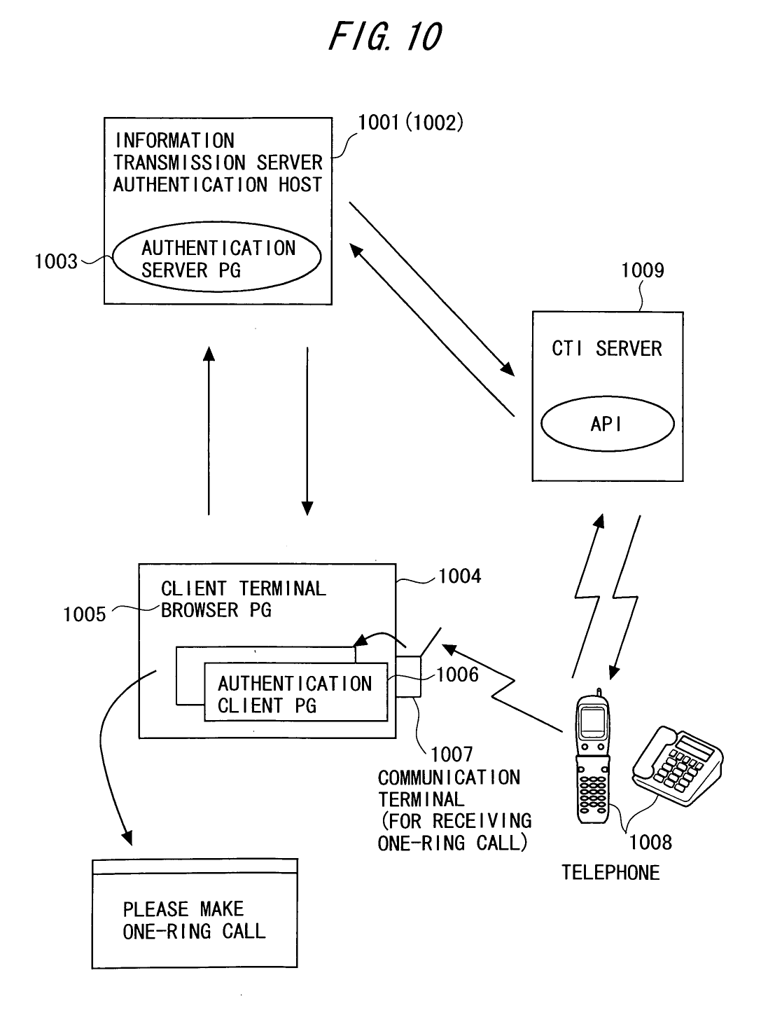

In FIGS. 10 and 11, an information transmission server 1001 also serves as an authentication host 1002 and is constituted of a general-purpose network information processing unit. The information transmission server 1001 stores an authentication server program (PG) 1003. On the other hand, a client terminal 1004 stores a browser program 1005 and an authentication client program 1006, which function as a browser and an authentication client, respectively.

A user (i.e., member customer) is pre-registered in the authentication host 1002 (i.e., the information transmission server 1001). The registration is realized by making a direct access from the client terminal 1004 to the authentication host 1002 (i.e., the information transmission server 1001) to register a user's telephone 1008.

The thus generated information is stored in a storage area in the authentication host 1002, which is managed by the authentication server program 1003 as an authentication information database as shown in FIG. 11.

Next, for using the contents or the application program of the information transmission server 1001, the user makes an access to a predetermined URL of the information transmission server 1001 through the browser program 1005 of the client terminal 1004.

Next, the user enters a user ID and a password requested from the authentication server program 1003 on the client terminal 1004 (the entry of the user ID and the password may be omitted). After that, the authentication server program 1003 sends an execution instruction for urging the “one-ring call” to the authentication client program 1006. At this time, the authentication processing of the user ID and the password may be omitted.

Next, the authentication client program 1006 goes into a standby state for a one-ring call from the telephone 1008. The user makes an outgoing one-ring call from the telephone 1008 to the communication terminal 1007. The one-ring call is made by setting the telephone 1008 in a caller line identity display (i.e., presentation) mode and making a call to the communication terminal 1007 with the use of a push button. Then, the call is hung up immediately after being made (accordingly, the “one-ring call” is made). At this time, although the communication terminal 1007 can recognize the call from the telephone 1008 owing to the caller line identity display function, a carrier (i.e., telephone line operating company) does not charge for such a call processing.

After confirming the incoming “one-ring call”, the communication terminal 1007 transmits the caller's number of the telephone 1008 and a unique ID (specifically, its own unique ID) of the communication terminal 1007 for receiving the one-ring call to the authentication client program 1006 of the client terminal 1004.

Next, the authentication client program 1006 encrypts: (a) the caller's number from the telephone 1008; (b) the unique ID of the communication terminal 1007 for receiving the one-ring call; and (c) the unique ID of the client terminal 1004 (e.g., PC) loaded with the authentication client program 1006 to send the encrypted information to the authentication server program 1003. For the encryption, general-purpose SSL communication or the like can be used.

Next, the authentication server program 1003 having received the information (a) to (c) decrypts the information and sends an execution instruction for making a callback to the telephone 1008 to a CTI server 1009. The CTI server 1009 makes a call to the telephone 1008 to execute a callback.

After the reception of the callback, the user operates the push button of the telephone 1008 in accordance with a CTI guidance transmitted from the CTI server 1009 to input a predetermined approval. The thus input information is returned as an approval notification to the CTI server 1009 by means of a sound, a push signal, or the like.

Next, the CTI server 1009 sends a notification that the information of the approval has been received from the user to the authentication server program 1003. By the series of processings, the authentication server program 1003 completes the authentication of the user.

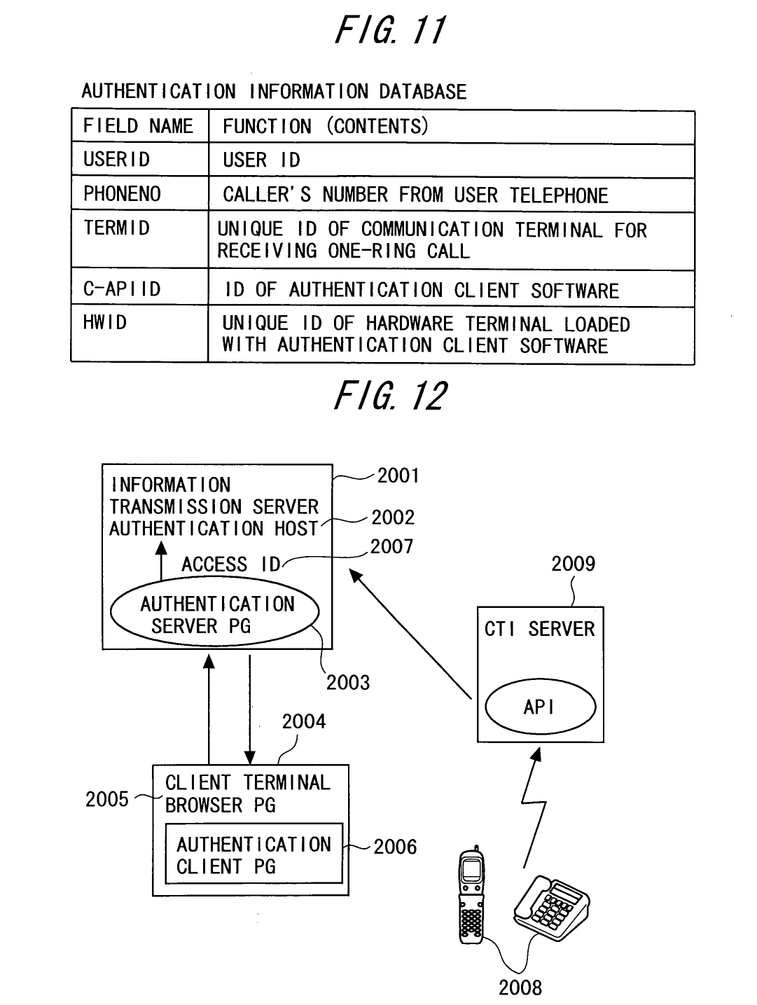

Subsequently, a modification example of the third embodiment will be described with reference to FIGS. 12 to 14. This modification example is in a communication procedure in the case where the client terminal does not include a communication terminal for a one-ring call. The modification example includes the case where an application such as an application program (e.g., i-appli (registered trademark of NTT DoCoMo Inc.) by NTT DoCoMo Inc.) downloaded into the mobile phone having a network access function is used.

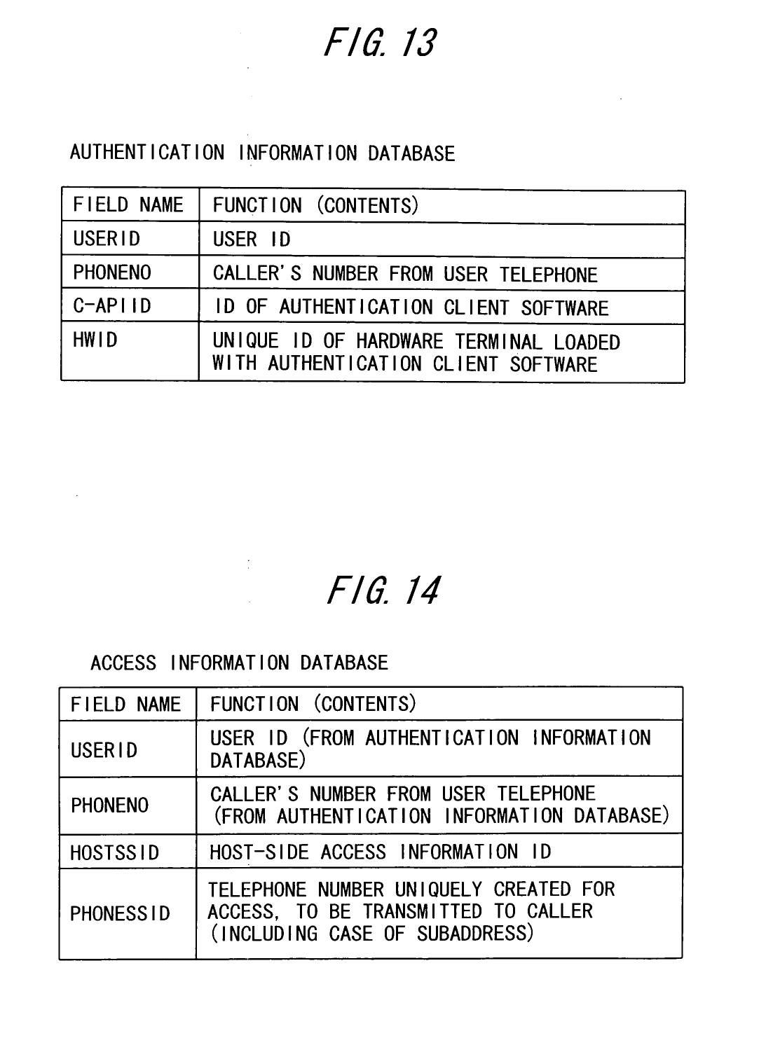

For the user registration in an authentication host 2002 (i.e., an information transmission server 2001), an authentication server program 2003 stores information shown in FIG. 13 in an authentication information database. A method of constructing the database is the same as that in the third embodiment described above.

Next, when using the contents or the application program, the user makes an access to the information transmission server 2001 through the browser program 2005 in the client terminal 2004.

Next, the authentication server program 2003 creates an access ID 2007 for uniquely identifying the above-described access to pass the created access ID 2007 to an authentication client program 2006 or the browser program 2005 on the client terminal 2004 via the information transmission server 2001. The authentication server program 2003 stores the information in an access information database shown in FIG. 14.

Next, the user operates the client terminal 2004 in accordance with the authentication client program 2006 or enters the telephone number displayed on the browser program 2005 to the telephone 2008 to make a one-ring call.

Next, the CTI server 2009 receives a caller's number and subaddress information from the telephone 2008. The CTI server 2009 transmits the information received by the authentication server program 2003 in encrypted communication such as SSL communication.

Next, the authentication server program 2003 authenticates the user based on the information stored in the access information database (FIG. 14) and the information received from the CTI-server 2009.

The authentication server program 2003 creates and sends an approval notification that represents information of approval from the user to the information transmission server 2001 and notifies the authentication client program 2006 or the browser program 2005 on the client terminal 2004 of the result of authentication to terminate the authentication processing.

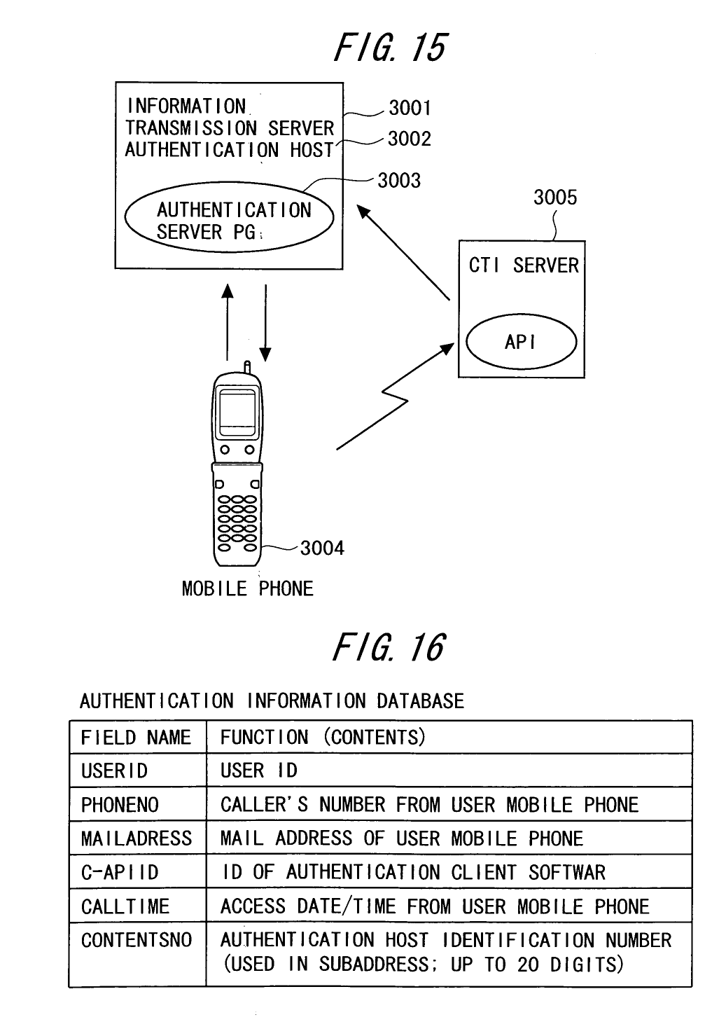

Next, another modification example of the third embodiment will be described with reference to FIGS. 15 and 16. This modification example relates to a communication procedure when a network-connectable mobile phone is used to make an access to a WEB site.

In the modification example, for pre-registering the user in an authentication host 3002 (i.e., an information transmission server 3001), an authentication server program 3003 stores information shown in FIG. 16 in the authentication information database. An identification number of a self-station authentication host 3002 is pre-registered in the CTI server 3005.

For using the contents or the application program, the user makes an access to the information transmission server 3001 through a mobile phone 3004. The authentication server program 3003 notifies, directly or after the authentication of a user ID and a password, the mobile phone 3004 of a message urging a one-ring call. At this time, an access destination telephone number, or the combination of the access destination telephone number and a subaddress is displayed as the message. Herein, the subaddress is an authentication host identification number. Specifically, the numbers following “##” in “0120123456##0123456789” correspond to the subaddress.

The user temporarily interrupts a WEB session on the mobile phone 3004 and makes a one-ring call to the access destination notified as described above. After the confirmation of the reception of the one-ring call, the CTI server 3005 identifies the subaddress and transmits the caller's number of the mobile phone 3004 of the user and an access date/time (i.e., calling date/time) to the corresponding authentication host 3002 in the encrypted communication such as the SSL communication.

Next, the authentication server program 3003 having received the information from the CTI server 3005 transmits URL information and authentication establishment information for restarting the WEB access in an electronic mail format to the mobile phone 3004 of the user. The electronic mail is transmitted to the address assigned to the mobile phone 3004 as a destination. It is desirable that the electronic mail be directly received by the mobile phone 3004.

The user who has received the electronic mail on the mobile phone 3004 selects and determines URL information described in the text of the electronic mail to restart the WEB communication session.

### OTHER MODIFICATION EXAMPLES

The processing in each of the above-described embodiments is provided as a program executable on the computer, and can be provided through a recording medium such as a CD-ROM or a flexible disk and further a communication line. Each of the processings in each of the above-described embodiments can also be carried out by selecting and combining a plurality of arbitrary processings or all of the processings.

1. A member authentication method, comprising the steps of:
recognizing a caller's number of a mobile terminal based on a call made from the mobile terminal in a caller line identity presentation state to a specific number for membership authentication; and
executing a member authentication processing by searching a database for a member-subscribed caller number corresponding to the caller's number for verification, after the call is hung up without waiting for a receiving party to answer, and outputting the result of the member authentication processing.

2. The member authentication method according to claim 1, wherein the number of rings of the call on the receiving party is limited by control of control means connected to the mobile terminal, in order to hang up the call before the receiving party answers.

3. The member authentication method according to claim 1, wherein the number of rings of the call on the receiving party is limited by the mobile terminal itself, in order to hang up the call without waiting for the receiving party to answer.

4. The member authentication method according to claim 2, wherein the number of rings of the call on the receiving party is at least one.

5. A member authentication method, comprising:
an identification step of identifying an individual number of a mobile terminal present within a service area, in accordance with power activation of the mobile terminal; and
an authentication step of receiving the individual number from the identification step and comparing the received individual number with a content of a database for verification,
wherein the authentication step further includes: recognizing, when a predetermined number of power-ON and power-OFF operations of the mobile terminal are repeated within a predetermined time, an authentication request from the mobile terminal; searching the database for the individual number; and outputting the result of member authentication.

6. A member authentication method, comprising the steps of:
transmitting a request of using a content or an application from a client terminal to an information transmission server;
receiving, at the client terminal, an instruction of executing hang-up of a call immediately after the call is made, from an authentication server that operates in conjunction with the information transmission server;
urging, at the client terminal, the execution of hang-up of the call immediately after the call is made from a telephone of a user;
transmitting a caller's number of the telephone and an ID of the client terminal to the authentication server upon acceptance of the processing of hanging up the call immediately after the call is made from the telephone;
executing a callback to the telephone from the authentication server through a CTI server; and
notifying the authentication server of authentication completion after accepting an approval operation performed in the telephone in response to the callback.

7. A member authentication system, comprising:
means for recognizing a caller's number of a mobile terminal based on a call made from the mobile terminal in a caller line identity presentation state to a specific number for membership authentication; and
means for executing a member authentication processing by searching a database for a member-subscribed caller number corresponding to the caller's number for verification, after the call is hung up without waiting for a receiving party to answer, and outputting the result of the member authentication processing.

8. The member authentication system according to claim 7, wherein the number of rings of the call on the receiving party is limited by control of control means connected to the mobile terminal, in order to hang up the call before the receiving party answers.

9. The member authentication system according to claim 7, wherein the number of rings of the call on the receiving party is limited by the mobile terminal itself in order to hang up the call without waiting for the receiving party to answer.

10. The member authentication system according to claim 8, wherein the number of rings of the call on the receiving party is at least one.

11. A member authentication system, comprising:
an identification means for identifying an individual number of a mobile terminal present within a service area, in accordance with power activation of the mobile terminal; and
an authentication means for receiving the individual number from the identification means and comparing the received individual number with a content of a database for verification,
wherein the authentication means further recognizes, when a predetermined number of power-ON and power-OFF operations of the mobile terminal are repeated within a predetermined time, an authentication request from the mobile terminal, searches the database for the individual number, and outputs the result of member authentication.

12. A member authentication system, comprising:
means for transmitting a request of using a content or an application from a client terminal to an information transmission server;
means for receiving, at the client terminal, an instruction of executing hang-up of a call immediately after the call is made, from an authentication server that operates in conjunction with the information transmission server;
means for urging, at the client terminal, the execution of hang-up of the call immediately after the call is made from a telephone of a user;
means for transmitting a caller's number of the telephone and an ID of the client terminal to the authentication server upon acceptance of the processing of hanging up the call immediately after the call is made from the telephone;
means for executing a callback to the telephone from the authentication server through a CTI server; and
means for notifying the authentication server of authentication completion after accepting an approval operation performed in the telephone in response to the callback.
